(19) United States
(12) Patent Application Publication
(10) Pub. No.: US 2025/0372016 A1
(43) Pub. Date: Dec. 4, 2025

(54) POWER SUPPLY, DISPLAY DEVICE INCLUDING THE SAME, AND ELECTRONIC DEVICE INCLUDING THE SAME

(71) Applicant: Samsung Display Co., LTD., Yongin-si (KR)

(72) Inventor: Eunyoul BACK, Yongin-si (KR)

(21) Appl. No.: 19/064,526

(22) Filed: Feb. 26, 2025

(30) Foreign Application Priority Data
May 31, 2024 (KR) 10-2024-0071530

(51) Int. Cl. G09G 3/3233; G09G 3/32

(52) U.S. Cl. CPC G09G 3/3233; G09G 3/32; G09G 2330/023

(57) ABSTRACT

A power supply includes: a converter configured to output a power supply voltage based on an output control signal; a first capacitor configured to discharge a first clamp voltage to a first resistor in a first mode and be to charged with the first clamp voltage in a second mode; and a second capacitor configured to be charged with a second clamp voltage in the first mode and to discharge the second clamp voltage to the first resistor in the second mode.

### CROSS-REFERENCE TO RELATED APPLICATION

The present application claims priority to and the benefit of Korean Patent Application No. 10-2024-0071530, filed on May 31, 2024, in the Korean Intellectual Property Office, the entire disclosure of which is incorporated herein by reference.

### BACKGROUND

### Field

Aspects of some embodiments of the present disclosure relate to a power supply, a display device including the same, and an electronic device including the same.

### 2. DESCRIPTION OF THE RELATED ART

A display device generally includes a DC-DC converter that generates high-potential power and low-potential power required to drive pixels by converting input power supplied from the outside. The DC-DC converter supplies the generated high-potential power and low-potential power to the pixels through power lines.

A driving current flowing through the pixel is dependent on the high-potential power. In order to stably provide a target driving current to pixels, a DC-DC converter may generate high-potential power while operating in various driving methods.

Meanwhile, when the driving method is switched, ripples may occur in the high-potential power and low-potential power output from the DC-DC converter, and the quality of images displayed by a display device may deteriorate.

The above information disclosed in this Background section is only for enhancement of understanding of the background and therefore the information discussed in this Background section does not necessarily constitute prior art.

### SUMMARY

Aspects of some embodiments of the present disclosure include a power supply, a display device, and an electronic device, in which power loss of the power supply is minimized or reduced by reducing a switching frequency through independent operations in a first mode and a second mode.

Aspects of some embodiments of the present disclosure include a power supply, a display device, and an electronic device, in which, when switching a driving mode, a transition time of a control signal may be reduced to output a power supply voltage with relatively improved reliability and the quality of images displayed on a display panel may be relatively improved.

According to some embodiments of the present disclosure, a power supply includes a converter configured to output a power supply voltage based on an output control signal, a first capacitor configured to discharge a first clamp voltage to a first resistor in a first mode and be charged with the first clamp voltage in a second mode, and a second capacitor configured to be charged with a second clamp voltage in the first mode and discharge the second clamp voltage to the first resistor in the second mode.

According to some embodiments, the power supply may further include a plurality of switches configured to be independently driven according to the first mode and the second mode.

According to some embodiments, the plurality of switches may include a first sub-switch and a third sub-switch connected in parallel to the first capacitor, and a second sub-switch and a fourth sub-switch connected in parallel to the second capacitor.

According to some embodiments, the first sub-switch and the second sub-switch may be turned off in the first mode and turned on in the second mode, and the third sub-switch and the fourth sub-switch may be turned on in the first mode and turned off in the second mode.

According to some embodiments, the third sub-switch may be between the first capacitor and the first resistor, and the second sub-switch may be between the second capacitor and the first resistor.

According to some embodiments, the power supply may further include an output buffer configured to supply the second clamp voltage to the second capacitor in the first mode and supply the first clamp voltage to the first capacitor in the second mode.

According to some embodiments, the first sub-switch may be between the first capacitor and the output buffer, and the fourth sub-switch may be between the second capacitor and the output buffer.

According to some embodiments, the power supply may further include a comparator configured to supply an input control signal to an output terminal, wherein the output terminal may be configured to output the output control signal based on a voltage applied to a first node between the comparator and the first resistor.

According to some embodiments, the output control signal may have a voltage of a first level in the first mode and a voltage of a second level in the second mode.

According to some embodiments, the voltage of the first level and the voltage of the second level may be equal to the first clamp voltage and the second clamp voltage, respectively.

According to some embodiments, a time taken when the output control signal transitions from the voltage of the first level to the voltage of the second level may be proportional to a change value of the power supply voltage when switching from the first mode to the second mode.

According to some embodiments of the present disclosure, a display device includes: a display panel comprising pixels, a main controller configured to supply an output control signal to a converter, and one or more converters configured to supply, to the pixels, a power supply voltage generated based on the output control signal, wherein the main controller includes a first capacitor configured to discharge a first clamp voltage to a first resistor in a first mode and be charged with the first clamp voltage in a second mode, and a second capacitor configured to be charged with a second clamp voltage in the first mode and discharge the second clamp voltage to the first resistor in the second mode.

According to some embodiments, the converter may be configured to output the power supply voltage in a first driving method in the first mode and output the power supply voltage in a second driving method in the second mode.

According to some embodiments, the converter may include a plurality of transistors configured to be turned on alternately with each other, and during a same time interval, a turn-on number of the plurality of transistors in the second driving method may be less than a turn-on number of the plurality of transistors in the first driving method.

According to some embodiments, the power supply voltage may include a first power supply voltage and a second power supply voltage lower than the first power supply voltage, and the converter may include a first converter configured to supply the first power supply voltage to the pixels, and a second converter configured to supply the second power supply voltage to the pixels.

According to some embodiments, the display device may further include a plurality of switches configured to be independently driven according to the first mode and the second mode.

According to some embodiments, the plurality of switches may include an first sub-switch and a third sub-switch connected in parallel to the first capacitor, and a second sub-switch and a fourth sub-switch connected in parallel to the second capacitor.

According to some embodiments, the first sub-switch and the second sub-switch may be turned off in the first mode and turned on in the second mode, and the third sub-switch and the fourth sub-switch may be turned on in the first mode and turned off in the second mode.

According to some embodiments, the display device may further include an output buffer configured to supply the second clamp voltage to the second capacitor in the first mode and supply the first clamp voltage to the first capacitor in the second mode.

According to some embodiments of the present disclosure, an electronic device includes: a processor configured to provide input image data to a display device, the display device configured to display an image based on the input image data, and a power supply configured to supply a power supply voltage to the display device. According to some embodiments, the power supply may include a converter configured to output a power supply voltage based on an output control signal, a first capacitor configured to discharge a first clamp voltage to a first resistor in a first mode and be charged with the first clamp voltage in a second mode, and a second capacitor configured to be charged with a second clamp voltage in the first mode and discharge the second clamp voltage to the first resistor in the second mode.

### BRIEF DESCRIPTION OF THE DRAWINGS

FIG. 1 is a block diagram illustrating a display device according to some embodiments of the present disclosure.

FIG. 2 is a circuit diagram illustrating an example of a pixel included in the display device of FIG. 1.

FIG. 3 is a block diagram illustrating aspects of a DC-DC converter and a main controller of a power supply of FIG. 1 according to some embodiments.

FIG. 4 is a block diagram illustrating aspects of a first converter of FIG. 3 according to some embodiments.

FIG. 5 is a block diagram illustrating aspects of a second converter of FIG. 3 according to some embodiments.

FIG. 6 is a diagram illustrating an example in which the first converter generates an inductor current in a first driving method according to some embodiments.

FIG. 7 is a diagram illustrating an example in which the first converter generates an inductor current in a second driving method according to some embodiments.

FIG. 8 is a diagram illustrating aspects of a main controller according to some embodiments of the present disclosure.

FIG. 9 is a diagram illustrating an example in which the main controller of FIG. 8 is driven in a first mode according to some embodiments.

FIG. 10 is a diagram illustrating an example in which the main controller of FIG. 8 is driven in a second mode according to some embodiments.

FIG. 11 is a diagram for describing an operation of a power supply in a first mode and a second mode according to some embodiments of the present disclosure.

FIG. 12 is a diagram for describing an operation of a power supply in a first mode and a second mode in accordance with a comparative example.

FIG. 13 is a block diagram illustrating an electronic device including a display device according to some embodiments of the present disclosure.

FIG. 14 is a perspective view illustrating an example in which the electronic device of FIG. 13 is implemented as a tablet personal computer (PC).

FIG. 15 is a perspective view illustrating an example in which the electronic device of FIG. 13 is implemented as a smartphone.

### DETAILED DESCRIPTION

Hereinafter, aspects of some embodiments of the present disclosure will be described in more detail with reference to the accompanying drawings. It should be noted that only the parts necessary to understand operations according to some embodiments of the present disclosure will be described below, and the description of the other parts will be omitted for brevity. In addition, embodiments according to the present disclosure are not limited to the embodiments described herein and may be embodied in other forms. Hereinafter, embodiments of the present disclosure will be described in more detail so that those of ordinary skill in the art can easily carry out the present disclosure.

It will be understood that when a portion is referred to as being “connected to” another portion, it may be “directly connected to” the other portion or “indirectly connected to” the other portion with intervening portions therebetween. The terminology used herein is intended to describe specific embodiments and is not intended to limit the present disclosure. It will be understood that the terms “comprise,” “include,” or “have” as used herein specify the presence of stated elements, but do not preclude the presence or addition of one or more other elements. The expression “at least one of X, Y, or Z” and “at least one selected from the group consisting of X, Y, and Z” may be interpreted as one X, one Y, one Z, or any combination of two or more of X, Y, and Z (e.g., XYZ, XYY, YZ, ZZ, etc.). The term “and/or” as used herein includes any combination of one or more of the elements.

It will be understood that although the terms such as “first,” “second,” etc. may be used to describe various elements, these elements should not be limited by these terms. These terms are only used to distinguish one element from another. Accordingly, a first element may be referred to as a second element without departing from the scope of the present disclosure.

Spatially relative terms such as “below,” “above,” etc. may be used for descriptive purposes, thereby describing the relationship between one element or feature and another element(s) or feature(s) as illustrated in the drawings. Spatially relative terms are intended to include different directions in use, operation, and/or manufacture, in addition to the directions depicted in the drawings. For example, when the device illustrated in the figures is turned over, elements depicted as being located “below” other elements or features are located “above” the other elements or features. Accordingly, in the present disclosure, the term “below” may include both up and down directions. In addition, the device may be oriented in other directions (e.g., rotated by 90 degrees or in other orientations), and thus, the spatially relative terms as used herein should be interpreted accordingly.

Various embodiments are described with reference to drawings that schematically illustrate ideal embodiments. Accordingly, it will be expected that the shapes may vary depending on, for example, tolerances and/or manufacturing techniques. Accordingly, the embodiments disclosed herein should not be construed as being limited to the specific shapes illustrated herein, but should be construed to include changes in shapes that occur, for example, as a result of manufacturing. As such, the shapes illustrated in the drawings may not depict the actual shapes of the areas of the device, and the present embodiments are not limited thereto.

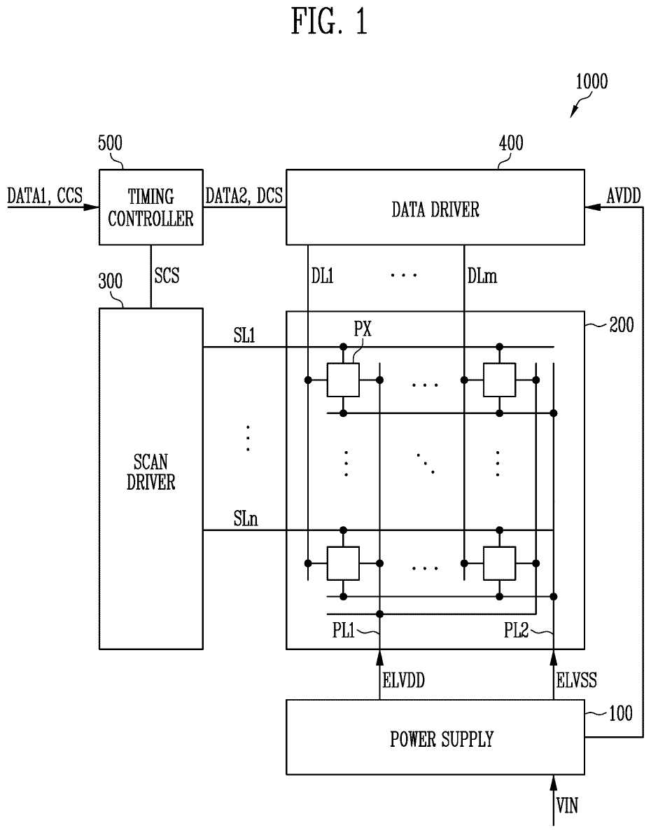

FIG. 1 is a block diagram illustrating a display device according to some embodiments of the present disclosure.

Referring to FIG. 1, a display device 1000 may include a display panel 200, a scan driver 300, a data driver 400, a timing controller 500, and a power supply 100.

The display panel 200 may include scan lines SL1 to SLn (where n is a positive integer), data lines DL1 to DLm (where m is a positive integer), and pixels PX. In addition, the display panel 200 may include a first power line PL1 and a second power line PL2.

In the present disclosure, the type of display panel 200 is not particularly limited. For example, the display panel 200 may be a self-luminous display panel. In this case, the display panel 200 may include a plurality of light emitting elements. For example, the light emitting element may be selected as an organic light emitting diode (LED). In addition, the light emitting element may be selected as an inorganic LED, such as micro LED or quantum dot LED. In addition, the light emitting element may be an element including a composite of an organic material and an inorganic material.

The pixel PX may be connected to the first power line PL1, the second power line PL2, a corresponding one of the scan lines SL1 to SLn, and a corresponding one of the data lines DL1 to DLm. Hereinafter, “connection” may include not only electrical connection but also physical connection and may include not only direct connection but also indirect connection through other components.

The pixel PX may include a light emitting element and at least one transistor that provides a driving current to the light emitting element or causes a driving current to be provided to the light emitting element.

The pixel PX may emit light with a luminance corresponding to a data voltage (or a data signal) provided through the data line in response to a scan signal provided through the scan line. For example, the pixel PX located in an n-th row and an m-th column may emit light with a luminance corresponding to a data voltage (or a data signal) provided through an m-th data line DLm in response to a scan signal provided through an n-th scan line SLn.

The scan driver 300 may generate scan signals based on a scan control signal SCS and may sequentially supply the scan signals to the scan lines SL1 to SLn. The scan control signal SCS may include a scan start signal (or a scan start pulse), scan clock signals, etc., and may be provided from the timing controller 500. For example, the scan driver 300 may include a shift register that sequentially generates and outputs scan signals of a pulse form corresponding to the scan start signal of a pulse form (e.g., a pulse of a gate-on voltage level) by using the scan clock signals.

The data driver 400 may generate data voltages (or data signals) based on image data DATA2 and a data control signal DCS provided from the timing controller 500 and may provide the data voltages to the data lines DL1 to DLm. The data control signal DCS is a signal that controls the operation of the data driver 400 and may include a load signal (or a data enable signal) that indicates an output of a valid data voltage.

For example, the data driver 400 may use gamma voltages to generate a data voltage corresponding to a data value (or a grayscale value) included in the image data DATA2. The gamma voltages may be generated by the data driver 400 or may be provided from a separate gamma voltage generation circuit (e.g., a gamma integrated circuit). For example, the data driver 400 may select one of the gamma voltages based on the data value and output the selected gamma voltage as the data signal.

The timing controller 500 may receive input image data DATA1 and a control signal CCS from the outside (e.g., an application processor) and may generate the scan control signal SCS and the data control signal DCS based on the control signal CCS. The control signal CCS may include a vertical synchronization signal, a horizontal synchronization signal, a clock signal, etc. In addition, the timing controller 500 may convert the input image data DATA1 to generate the image data DATA2. For example, the timing controller 500 may convert the input image data DATA1 into the image data DATA2 having a format that is usable by the data driver 400.

FIG. 1 illustrates that the scan driver 300, the data driver 400, and the timing controller 500 are configured independently of each other, but this is only an example, and embodiments according to the present disclosure are not limited thereto. For example, at least one of the scan driver 300, the data driver 400, or the timing controller 500 may be formed in the display panel 200, or may be implemented as an IC, and may be mounted on a flexible circuit board so as to connect to the display panel 200. For example, the scan driver 300 may be formed in the display panel 200. In addition, at least two of the scan driver 300, the data driver 400, and the timing controller 500 may be implemented with a single IC.

The power supply 100 according to some embodiments of the present disclosure may generate a first power supply voltage ELVDD by using input power VIN and supply the first power supply voltage ELVDD to the first power line PL1, and may supply the second power supply voltage ELVSS and supply the second power supply voltage ELVSS to the second power line PL2. The first power supply voltage ELVDD and the second power supply voltage ELVSS are voltages required for the operation of the pixel PX, and the first power supply voltage ELVDD may have a higher voltage level than a voltage level of the second power supply voltage ELVSS.

For example, the power supply 100 may be implemented as a power management integrated circuit (PMIC) and may convert the input power VIN into the first power supply voltage ELVDD and the second power supply voltage ELVSS through switching operations on transistors provided therein.

In addition, the power supply 100 may generate a third power supply voltage AVDD by using the input power VIN and provide the third power supply voltage AVDD to the data driver 400. The third power supply voltage AVDD is a voltage required to drive the data driver 400 (e.g., to generate gamma voltages).

The power supply 100 may manage the magnitude and sequence of the voltages ELVDD, ELVSS, and AVDD provided to the display panel 200 and the data driver 400 based on the input power VIN. For example, the first power supply voltage ELVDD and the second power supply voltage ELVSS may be positive and negative voltages required to drive the pixels PX.

The power supply 100 may implement, as boost converters, a converter that converts the voltage of the input power VIN into the first power supply voltage ELVDD and a converter that converts the voltage of the input power VIN into the third power supply voltage. In addition, the power supply 100 may implement, as an inverting buck boost converter, a converter that converts the voltage of the input power VIN into the second power supply voltage ELVSS. However, this is only an example and embodiments according to the present disclosure are not limited thereto.

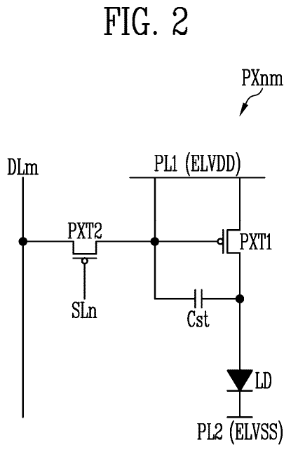

FIG. 2 is a circuit diagram illustrating an example of the pixel included in the display device of FIG. 1. Although various components are illustrated in FIG. 2, embodiments according to the present disclosure are not limited thereto, and according to various embodiments, a pixel circuit may include additional components or fewer components without departing from the spirit and scope of embodiments according to the present disclosure. Because the pixels PX of FIG. 1 are identical (or substantially identical) to each other, an nm-th pixel PXnm included in an n-th row and an m-th column is described on behalf of the pixels PX.

Referring to FIGS. 1 and 2, the nm-th pixel PXnm may be connected to an n-th scan line SLn and an m-th data line DLm. In addition, the pixel PX may be connected between the first power line PL1 and the second power line PL2.

The nm-th pixel PXnm may include at least one light emitting element LD, a first pixel transistor PXT1 (or a driving transistor), a second pixel transistor PXT2 (or a switching transistor), and a storage capacitor Cst. Each of the first pixel transistor PXT1 and the second pixel transistor PXT2 may include a silicon semiconductor and may be, for example, a P-type transistor. However, the first pixel transistor PXT1 and the second pixel transistor PXT2 are not limited thereto, and at least one of the first pixel transistor PXT1 or the second pixel transistor PXT2 may include an oxide semiconductor or may be implemented as an N-type transistor.

The at least one light emitting element may include a light emitting element LD. An anode electrode of the light emitting element LD may be connected to the first power line PL1 through the first pixel transistor PXT1, and a cathode electrode of the light emitting element LD may be connected to the second power line PL2. The light emitting element LD may generate light with a certain luminance in response to the amount of current (or a driving current ID) supplied from the first pixel transistor PXT1. The light emitting element LD may include an organic LED or an inorganic LED such as a micro LED or a quantum dot LED. In addition, the light emitting element LED may be a light emitting element including a composite of an organic material and an inorganic material. Although FIG. 2 illustrates that the nm-th pixel PXnm includes a single light emitting element LD, but according to some embodiments, the pixel PXnm may include a plurality of light emitting elements and the plurality of light emitting elements may be connected to each other in series, in parallel, or in series-parallel.

The first pixel transistor PXT1 may control the amount of driving current flowing to the light emitting element LD in response to the voltage applied to the gate electrode thereto. A first electrode (or a first transistor electrode) of the first pixel transistor PXT1 may be connected to the first power line PL1, and a second electrode (or a second transistor electrode) of the first pixel transistor PXT1 may be connected to one electrode (e.g., an anode electrode) of the light emitting element LD. The gate electrode of the first pixel transistor PXT1 may be connected to a second electrode of the second pixel transistor PXT2. The first electrode of the first pixel transistor PXT1 may be a source electrode, and the second electrode of the first pixel transistor PXT1 may be a drain electrode, but embodiments according to the present disclosure are not limited thereto.

The second pixel transistor PXT2 may be configured to receive a data voltage. For example, the first electrode of the second pixel transistor PXT2 may be connected to the m-th data line DLm. The second electrode of the second pixel transistor PXT2 may be connected to the first pixel transistor PXT1 (e.g., connected to the gate electrode of the first pixel transistor PXT1). The gate electrode of the second pixel transistor PXT2 may be connected to the n-th scan line SLn. When the scan signal of the gate-on voltage level is supplied to the n-th scan line SLn, the second pixel transistor PXT2 may be turned on and the data voltage may be transmitted from the m-th data line DLm to the first pixel transistor PXT1.

The storage capacitor Cst may be formed or connected between one node (e.g., a node between the gate electrode of the first pixel transistor PXT1 and the second electrode of the second pixel transistor PXT2) and another node (e.g., a node between the second electrode of the first pixel transistor PXT1 and one electrode of the light emitting element LD). The storage capacitor Cst may store the voltage (i.e., the data voltage) of the gate electrode of the first pixel transistor PXT1.

Meanwhile, FIG. 2 illustrates the nm-th pixel PXnm including the second pixel transistor PXT2 for transmitting the data voltage to the inside of the nm-th pixel PXnm, the storage capacitor Cst for storing the data voltage, and the first pixel transistor PXT1 for supplying, to the light emitting element LD, the driving current corresponding to the data voltage.

However, embodiments according to the present disclosure are not limited thereto, and the structure of the nm-th pixel PXnm may be variously modified. For example, the nm-th pixel PXnm may further include at least one transistor such as a transistor for compensating for a threshold voltage of the first pixel transistor PXT1, a transistor for initializing the gate electrode of the first pixel transistor PXT1, and/or a transistor element for controlling the emission time of the light emitting element LD.

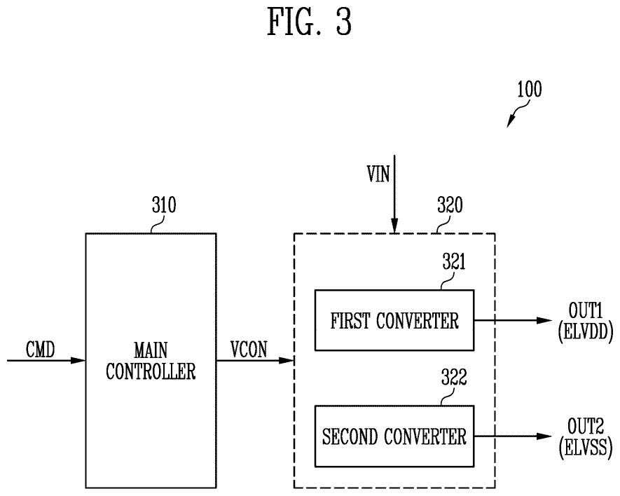

FIG. 3 is a block diagram illustrating aspects of a DC-DC converter and a main controller of the power supply of FIG. 1 according to some embodiments.

Referring to FIG. 3, the power supply 100 may include a main controller 310 and a DC-DC converter 320.

The main controller 310 may generate a control signal VCON to allow the DC-DC converter 320 to be driven according to a first mode or a second mode based on an external command CMD. Thereafter, the main controller 310 may provide the generated control signal VCON to a first converter 321 and a second converter 322. For example, a section in which the control signal VCON is enabled may correspond to the second mode, and a section in which the control signal VCON is disabled may correspond to the first mode.

The DC-DC converter 320 may operate in one of the first mode in which a general image is displayed and a second mode in which a displayable maximum luminance is limited, depending on the control signal VCON received from the main controller 310. For example, the second mode may be an always on display (AOD) mode in which simple display information is always displayed, or a certain display mode in which a screen is displayed at ultra-low luminance in a dark environment.

The first converter 321 may output the first power supply voltage ELVDD based on the voltage of the input power VIN and the control signal VCON. In addition, the second converter 322 may output the second power supply voltage ELVSS based on the voltage of the input power VIN and the control signal VCON.

The first converter 321 and the second converter 322 may be driven in different driving methods according to the first mode and the second mode. For example, in the first mode, the first converter 321 (or the second converter 322) may alternately turn on a plurality of transistors so that the first power supply voltage ELVDD is output in a first driving method of generating a first inductor current. At this time, the first inductor current is a current flowing through an inductor L1 included in the first converter 321 and used to determine the first power supply voltage ELVDD. The first driving method may be a continuous conduction mode (CCM) method. For example, the first converter 321 may be driven only in the CCM method, regardless of the load of the display panel in the first mode, so as to ensure output stability of the first power supply voltage ELVDD that has a significant effect on the emission of the pixel (see PX of FIG. 1).

In addition, in the second mode, the first converter 321 may output the first power supply voltage ELVDD in the second driving method of generating the first inductor current with fewer turn-on times than the first driving method. For example, the second driving method may be a discontinuous conduction mode (DCM) method. The second converter 322 may be driven in the same method as that of the first converter 321. For example, the second converter 322 may output the second power supply voltage ELVSS in the first driving method in the first mode. Additionally, the second converter 322 may output the second power supply voltage ELVSS in the second driving method in the second mode. However, this is only an example and embodiments according to the present disclosure are not limited thereto.

According to some embodiments, the main controller 310 may include a load detector that detects the load of the display panel. Accordingly, the main controller 310 may select the first mode or the second mode according to the load of the display panel. However, embodiments according to the present disclosure are not limited thereto.

As such, the DC-DC converter 320 according to some embodiments of the present disclosure may relatively reduce power consumption by adaptively selecting the driving methods of the first converter 321 and the second converter 322 according to the load of the display panel.

The DC-DC converter 320 may include a third converter that generates a third power supply voltage (see AVDD of FIG. 1). The description of the first converter 321 or the second converter 322 may be equally applied to the third converter. For convenience of explanation, the operation of the third converter is replaced with the description of the first converter 321 and the second converter 322.

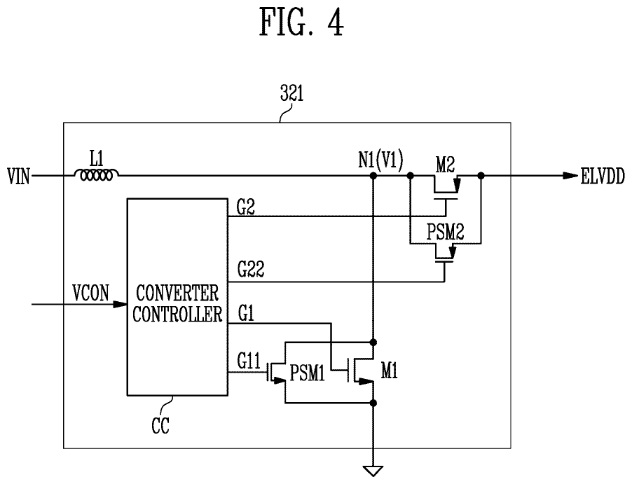

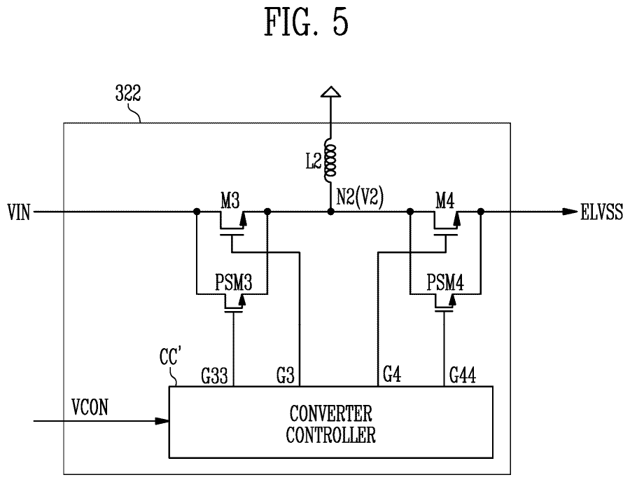

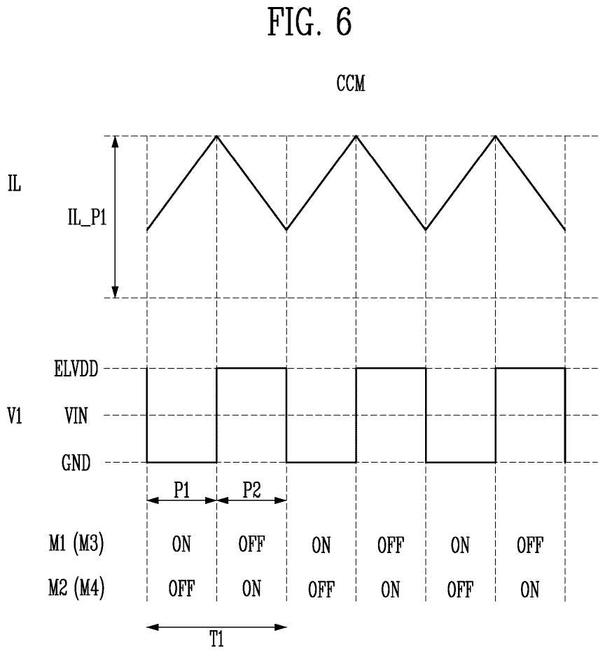

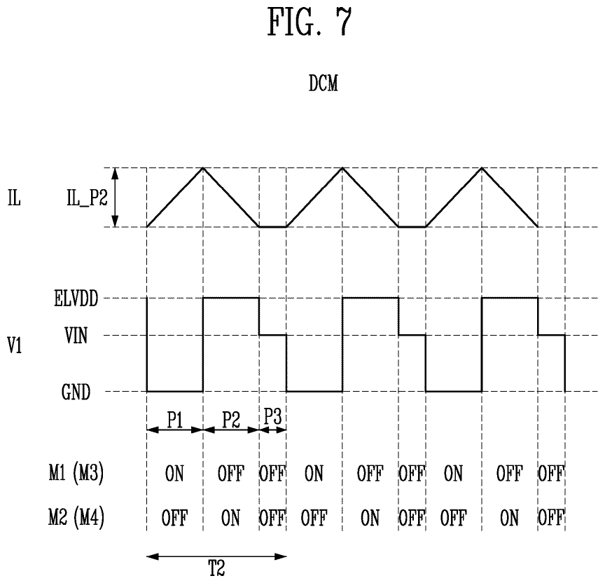

FIG. 4 is a block diagram illustrating aspects of the first converter of FIG. 3 according to some embodiments. FIG. 5 is a block diagram illustrating aspects of the second converter of FIG. 3 according to some embodiments. FIG. 6 is a diagram illustrating an example in which the first converter generates an inductor current in the first driving method. FIG. 7 is a diagram illustrating an example in which the first converter generates an inductor current in the second driving method.

Referring to FIG. 4, the first converter 321 may include a circuit part and a converter controller CC. The circuit part may include a first inductor L1, a first transistor M1, a first power-saving transistor PSM1, a second transistor M2, and a second power-saving transistor PSM2.

The first converter 321 may convert the input power VIN based on the control signal VCON and output the first power supply voltage ELVDD. For example, the first converter 321 may include a boost converter.

The first inductor L1 may be connected between an input terminal to which the voltage of the input power VIN is applied and the first node N1. The first power supply voltage ELVDD may be controlled based on the first inductor current flowing through the first inductor L1.

The first transistor M1 may be connected between the first node N1 and the ground. The first transistor M1 may be turned on by receiving the first control signal G1 from the converter controller CC and may perform control so that a current flows through the first inductor L1.

The first power-saving transistor PSM1 may be connected in parallel to the first transistor M1. The first power-saving transistor PSM1 may be turned on by receiving the first power-saving control signal G11 from the converter controller CC and may perform control so that a current flows through the first inductor L1. The first power-saving transistor PSM1 may perform the same (or substantially the same) operation as the first transistor M1.

The first power-saving transistor PSM1 may have a smaller size than the first transistor M1. In this case, the allowable current amount of the first power-saving transistor PSM1 may be smaller than the allowable current amount of the first transistor M1.

The second transistor M2 may be connected between the first node N1 and the first output terminal through which the first power supply voltage ELVDD is output. In the first mode, the second transistor M2 may be turned on alternately with the first transistor M1. Therefore, after the first transistor M1 is turned on and electromotive force is generated in the first inductor L1, the second transistor M2 may be turned on so that the voltage V1 of the first node is converted into the first power supply voltage ELVDD. The second transistor M2 may be turned on by receiving the second control signal G2 from the converter controller CC.

The second power-saving transistor PSM2 may be connected in parallel to the second transistor M2. The second power-saving transistor PSM2 may be turned on by receiving the second power-saving control signal G22 from the converter controller CC. The second power-saving transistor PSM2 may be turned on alternately with the first power-saving transistor PSM1. The second power-saving transistor PSM2 may perform substantially the same operation as the second transistor M2. According to some embodiments, the second power-saving transistor PSM2 may have a smaller size than the second transistor M2.

According to some embodiments, the first power-saving transistor PSM1 and the second power-saving transistor PSM2 may be omitted. For example, the first converter 321 may be operated by being configured only with the first transistor M1 and the second transistor M2.

According to some embodiments, the first and second transistors M1 and M2 may operate (perform a switching operation) only in the first mode, and the first and second power-saving transistors PSM1 and PSM2 may operate only in the second mode. For example, in the second mode, the first and second transistors M1 and M2 may be maintained in a turned-off state by the first and second control signals G1 and G2. In addition, in the first mode, the first and second power-saving transistors PSM1 and PSM2 may be maintained in a turned-off state by the first and second power-saving control signals G11 and G22.

During the switching of the transistor, power loss occurs due to parasitic capacitance between the electrodes of the transistor. Such parasitic capacitance increases as the size of the transistor increases, and the amount of power loss may also increase as the parasitic capacitance increases. Therefore, according to some embodiments, in the second mode for power saving, power consumption may be reduced by switching only the first and second power-saving transistors PSM1 and PSM2 each having a small size.

For example, as illustrated in FIG. 4, the first power-saving transistor PSM1 may have a smaller size than the first transistor M1. For example, the channel width and/or the channel length of the first power-saving transistor PSM1 may be smaller than the channel width and/or the channel length of the first transistor M1. In addition, each of the first transistor M1 and the first power-saving transistor PSM1 may be an n-channel metal oxide semiconductor (NMOS) transistor.

The second power-saving transistor PSM2 may have a smaller size than the second transistor M2. For example, the channel width and/or the channel length of the second power-saving transistor PSM2 may be smaller than the channel width and/or the channel length of the second transistor M2. In addition, each of the second transistor M2 and the second power-saving transistor PSM2 may be a p-channel metal oxide semiconductor (PMOS) transistor.

According to some embodiments, in the first mode, the first converter 321 may output the first power supply voltage ELVDD in the CCM method (the first driving method) using the first and second transistors M1 and M2, and in the second mode, the first converter 321 may output the first power supply voltage ELVDD in the DCM method (the second driving method) using the first and second power-saving transistors PSM1 and PSM2.

The converter controller CC may control on-off of the first transistor M1, the second transistor M2, the first power-saving transistor PSM1, and the second power-saving transistor PSM2. The first and second transistors M1 and M2 may be alternately turned on and off under the control of the converter controller CC. The first and second power-saving transistors PSM1 and PSM2 may be alternately turned on and off under the control of the converter controller CC.

According to some embodiments, the converter controller CC may set different driving frequencies in the first mode and the second mode. For example, the converter controller CC may control the transistors M1, M2, PSM1, and PSM2 at a driving frequency of about 1.5 MHZ (megahertz) in the first mode and at a driving frequency of about 500 kHz (kilohertz) in the second mode, based on the received control signal VCON. Accordingly, the switching number (turn-on times) of the transistors M1, M2, PSM1, and PSM2 in the second mode is reduced, thereby improving power loss due to switching of the transistors M1, M2, PSM1, and PSM2.

Referring to FIG. 5, the second converter 322 may include a circuit part and a converter controller CC′. The circuit part may include a second inductor L2, a third transistor M3, a third power-saving transistor PSM3, a fourth transistor M4, and a fourth power-saving transistor PSM4.

The second converter 322 may convert the input power VIN based on the control signal VCON and output the second power supply voltage ELVSS. For example, the second converter 322 may include an inverting buck boost converter.

The second inductor L2 may be connected between the second node N2 and the ground. The second power supply voltage ELVSS may be controlled based on the second inductor current flowing through the second inductor L2.

The third transistor M3 may be connected between the input power VIN and the second node N2. The third transistor M3 may be turned on by receiving the third control signal G3 from the converter controller CC′ and may perform control so that a current flows through the second inductor L2.

The third power-saving transistor PSM3 may be connected in parallel to the third transistor M3. The third power-saving transistor PSM3 may be turned on by receiving the third power-saving control signal G33 from the converter controller CC′ and may perform control so that a current flows through the second inductor L2. The third power-saving transistor PSM3 may perform substantially the same operation as the third transistor M3.

The third power-saving transistor PSM3 may have a smaller size than the third transistor M3. In this case, the allowable current amount of the third power-saving transistor PSM3 may be smaller than the allowable current amount of the third transistor M3.

The fourth transistor M4 may be connected between the second node N2 and the second output terminal. The fourth transistor M4 may be turned on alternately with the third transistor M3 in response to the fourth control signal G4 supplied from the converter controller CC′. Therefore, after the third transistor M3 is turned on and electromotive force is generated in the second inductor L2, the fourth transistor M4 may be turned on so that the input power VIN is converted into the second power supply voltage ELVSS and the second power supply voltage ELVSS is output to the second output terminal. At this time, the second node N2 may be defined as a common node of the third transistor M3, the fourth transistor M4, and the second inductor L2.

The fourth power-saving transistor PSM4 may be connected in parallel to the fourth transistor M4. The fourth power-saving transistor PSM4 may be turned on by receiving the fourth power-saving control signal G44 from the converter controller CC′. The fourth power-saving transistor PSM4 may be turned on alternately with the first power-saving transistor PSM4. The fourth power-saving transistor PSM4 may perform substantially the same operation as the fourth transistor M4. The fourth power-saving transistor PSM4 may have a smaller size than the fourth transistor M4.

According to some embodiments, the third power-saving transistor PSM3 and the fourth power-saving transistor PSM4 may be omitted. For example, the second converter 322 may operate with only the third transistor M3 and the fourth transistor M4.

According to some embodiments, the third and fourth transistors M3 and M4 may operate (perform a switching operation) only in the first mode, and the third and fourth power-saving transistors PSM3 and PSM4 may operate only in the second mode. For example, in the second mode, the third and fourth transistors M3 and M4 may be maintained in a turned-off state by the third and fourth control signals G3 and G4. In addition, in the first mode, the third and fourth power-saving transistors PSM3 and PSM4 may be maintained in a turned-off state by the third and fourth power-saving control signals G33 and G44.

The converter controller CC′ may control on-off of the third transistor M3, the fourth transistor M4, the third power-saving transistor PSM3, and the fourth power-saving transistor PSM4. The third and fourth transistors M3 and M4 may be alternately turned on and off under the control of the converter controller CC′. The third and fourth power-saving transistors PSM3 and PSM4 may be alternately turned on and off under the control of the converter controller CC′.

According to some embodiments, the converter controller CC′ may set different driving frequencies in the first mode and the second mode. Accordingly, the switching number (turn-on number) of the transistors M3, M4, PSM3, and PSM4 in the second mode is reduced, thereby improving power loss due to switching of the transistors M3, M4, PSM3, and PSM4.

In FIGS. 6 and 7, embodiments in which the first converter 321 of FIG. 4 operates in the first and second driving methods will be described. Descriptions redundant with those provided above are omitted. For example, the second converter 322 may output the second power supply voltage ELVSS through substantially the same switching operation.

Referring to FIGS. 4 and 6, the CCM method (the first driving method) may generate the first inductor current IL by alternately turning on the first and second transistors M1 and M2. As illustrated in FIG. 6, the first and second transistors M1 and M2 may repeatedly turn on and off in a first cycle T1. For example, during the first cycle T1, the turn-on state of the first transistor M1 and the turn-on state of the second transistor M2 do not overlap each other.

When the first transistor M1 is turned on in a first section P1, the voltage V1 of the first node has a ground level and the magnitude of the inductor current IL may increase due to the difference between the voltage of the input terminal and the voltage V1 of the first node.

When the first transistor M1 is turned off and the second transistor M2 is turned on in a second section P2, the voltage V1 of the first node rises to reach the first power supply voltage level ELVDD and the magnitude of the first inductor current IL may decrease due to the difference between the voltage of the input terminal and the voltage V1 of the first node.

As the first cycle T1 is repeated as described above, the magnitude of the first inductor current may continuously change. For example, the first driving method may be the CCM driving method.

Referring to FIGS. 4, 6, and 7, the DCM method (the second driving method) may include a third section in which the first and second transistors T1 and T2 are simultaneously turned off in the second cycle T2 (e.g., a discontinuous section). At this time, the first node voltage V1 may maintain the voltage of the input power VIN. Because one end of the first inductor L1 is open, the first inductor current IL does not change during the third section P3. In addition, the amplitude of the first inductor current IL may be small, compared to the first driving method. In other words, a peak change amount IL_P2 of the first inductor current IL in the second driving method may be smaller than a peak change amount IL_P1 of the first inductor current IL in the first driving method.

The driving frequency in the second mode may be lower than the driving frequency in the first mode. The driving frequency may be the frequencies of control signals supplied to the gate electrodes of the transistors M1, M2, PSM1, and PSM2 of the first converter 321. The driving frequency may be inversely proportional to the cycle. For example, the first driving frequency may be inversely proportional to the first cycle T1, and the second driving frequency may be inversely proportional to the second cycle T2.

According to some embodiments of the present disclosure, when the first converter 321 is driven in the second mode, the switching number (turn-on number) of the first and second transistors M1 and M2 may be reduced. Accordingly, power loss due to parasitic capacitance according to the switching number of the first and second transistors M1 and M2 may be relatively improved.

Because the operation of the second converter 322 is the same as the above-described operations, redundant descriptions thereof are omitted.

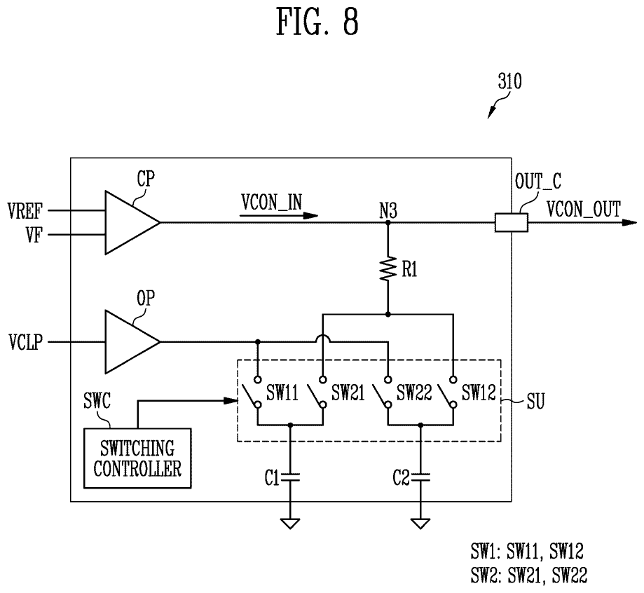

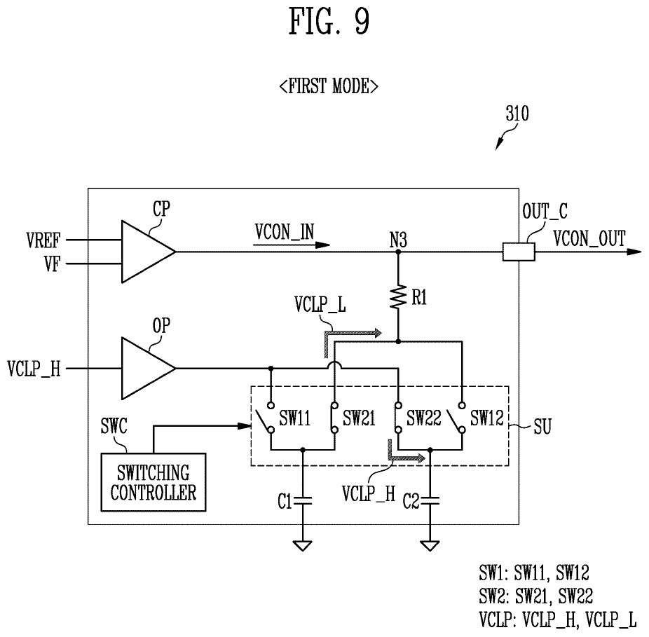

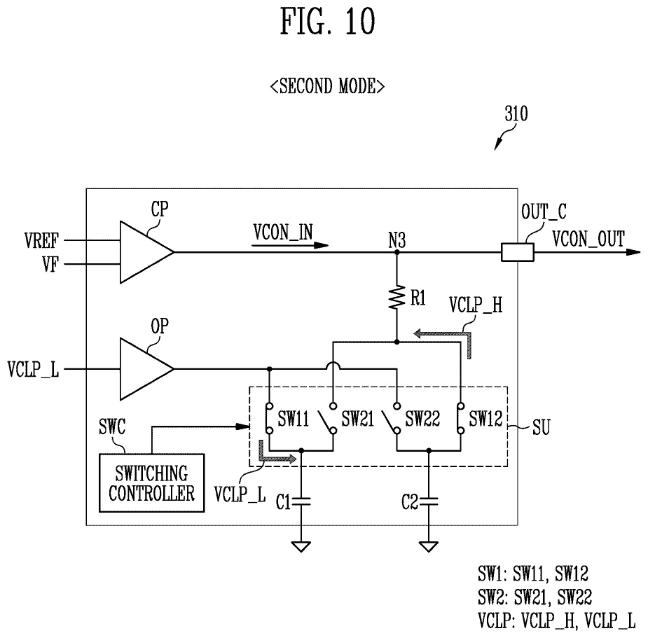

FIG. 8 is a diagram illustrating aspects of a main controller according to some embodiments of the present disclosure. FIG. 9 is a diagram illustrating an example in which the main controller of FIG. 8 is driven in a first mode. FIG. 10 is a diagram illustrating an example in which the main controller of FIG. 8 is driven in a second mode.

Referring to FIG. 8, the main controller 310 may include a comparator CP, an output buffer OP, a first resistor R1, a first capacitor C1, a second capacitor C2, and first switches SW1, second switches SW2, a switch controller SWC, and an output terminal OUT_C.

The comparator CP may include a first input terminal and a second input terminal. At this time, a reference voltage VREF may be supplied to the first input terminal of the comparator CP, and a feedback voltage VF may be supplied to the second input terminal of the comparator CP. The reference voltage VREF may be a voltage that serves as a reference for the first power supply voltage ELVDD. In addition, the feedback voltage VF may be the first power supply voltage ELVDD that the DC-DC converter 320 actually outputs. At this time, the comparator CP may output an input control signal VCON_IN of a logic low level when the level of the reference voltage VREF is lower than the level of the feedback voltage VF. The input control signal VCON_IN of the logic low level may be a control signal that causes the DC-DC converter 320 to operate in the first mode. In addition, the comparator CP may output the input control signal VCON_IN of a logic high level when the level of the reference voltage VREF is higher than or equal to the level of the feedback voltage VF. In other words, the input control signal VCON_IN of the logic high level may be a control signal that causes the DC-DC converter 320 to operate in the second mode.

Accordingly, the driving method of the first power supply voltage ELVDD output from the DC-DC converter 320 may change according to the voltage level of the input control signal VCON_IN. At this time, when the input control signal VCON_IN changes (for example, when the input control signal VCON_IN transitions from a logic low level to a high level, or from a logic high level to a logic low level), this may affect the first power supply voltage ELVDD. In other words, as it takes a longer time for the voltage level of the input control signal VCON_IN to change, the influence of output ripples on the first power supply voltage ELVDD may increase.

The output buffer OP may receive a clamp voltage VCLP. Accordingly, the output buffer OP may output the received clamp voltage VCLP to the switch unit SU. According to some embodiments, the output buffer OP may amplify and output the received clamp voltage VCLP. However, embodiments according to the present disclosure are not limited thereto.

The switch unit SU may include first switches SW1 and second switches SW2. The first switches SW1 may include an eleventh switch (or a first sub-switch) SW11 and a twelfth switch (or a second sub-switch) SW12. The second switches SW2 may include a twenty-first switch (or a third sub-switch) SW21 and a twenty-second switch (or a fourth sub-switch) SW22.

One end of the eleventh switch SW11 may be connected to the first capacitor C1, and the other end of the eleventh switch SW11 may be connected to the output buffer OP. One end of the twelfth switch SW12 may be connected to the second capacitor C2, and the other end of the twelfth switch SW12 may be connected to the first resistor R1.

One end of the twenty-first switch SW21 may be connected to the first capacitor C1, and the other end of the twenty-first switch SW21 may be connected to the first resistor R1. One end of the twenty-second switch SW22 may be connected to the second capacitor C2, and the other end of the twenty-second switch SW22 may be connected to the output buffer OP.

The eleventh switch SW11 and the twenty-first switch SW21 may be connected in parallel to the first capacitor C1. The twelfth switch SW12 and the twenty-second switch SW22 may be connected in parallel to the second capacitor C2.

One end of the first capacitor C1 may be connected to the ground, and the other end of the first capacitor C1 may be connected to the eleventh switch SW11 and the twenty-first switch SW21.

One end of the second capacitor C2 may be connected to the ground, and the other end of the second capacitor C2 may be connected to the twelfth switch SW12 and the twenty-second switch SW22.

Referring to FIGS. 8 to 10, the switch controller SWC may individually control the first switches SW1 and the second switches SW2. For example, in the first mode, the switch controller SWC may turn off the first switches SW1 and turn on the second switches SW2. Accordingly, the twenty-first switch SW21 may be turned on and the first clamp voltage VCLP_L having been previously charged in the first capacitor C1 may be discharged to the first resistor R1. Meanwhile, in the first mode, the output buffer OP may output the second clamp voltage VCLP_H. Accordingly, the second clamp voltage VCLP_H may be charged in the second capacitor C2 via the twenty-second switch SW22.

In addition, in the second mode, the switch controller SWC may turn on the first switches SW1 and turn off the second switches SW2. Accordingly, the twelfth switch SW12 may be turned on and the second clamp voltage VCLP_H having been previously charged in the second capacitor C2 may be discharged to the first resistor R1. The second clamp voltage VCLP_H of FIG. 10 may be the same as the second clamp voltage VCLP_H charged in the second capacitor C2 in FIG. 9. Meanwhile, in the second mode, the output buffer OP may output the first clamp voltage VCLP_L. Accordingly, the first clamp voltage VCLP_L may be charged in the first capacitor C1 via the eleventh switch SW11. At this time, the first clamp voltage VCLP_L charged in the first capacitor C1 in FIG. 10 may be the same as the first clamp voltage VCLP_L having been previously charged in the first capacitor C1 in FIG. 9.

The first clamp voltage VCLP_L may have the same level as the input control signal VCON_IN of the logic low level. In addition, the second clamp voltage VCLP_H may have the same level as the input control signal VCON_IN of the logic high level. However, this is only an example and the present disclosure is not limited thereto.

The output terminal OUT_C may output an output control signal VCON_OUT based on the voltage supplied to the third node N3. In the first mode, the comparator CP may supply the input control signal VCON_IN of a logic low level VCON_L to the third node N3. In addition, when switching from the second mode to the first mode, the twenty-first switch SW21 may be turned on and the first clamp voltage VCLP_L having been previously charged in the first capacitor C1 may be discharged to the third node N3. Accordingly, the output terminal OUT_C may output an output control signal VCON_OUT based on the input control signal VCON_IN of the logic low level VCON_L and the first clamp voltage VCLP_L discharged to the third node N3.

The output control signal VCON_OUT may be the same as the control signal (see VCON of FIG. 3) supplied to the DC-DC converter (see 320 of FIG. 3).

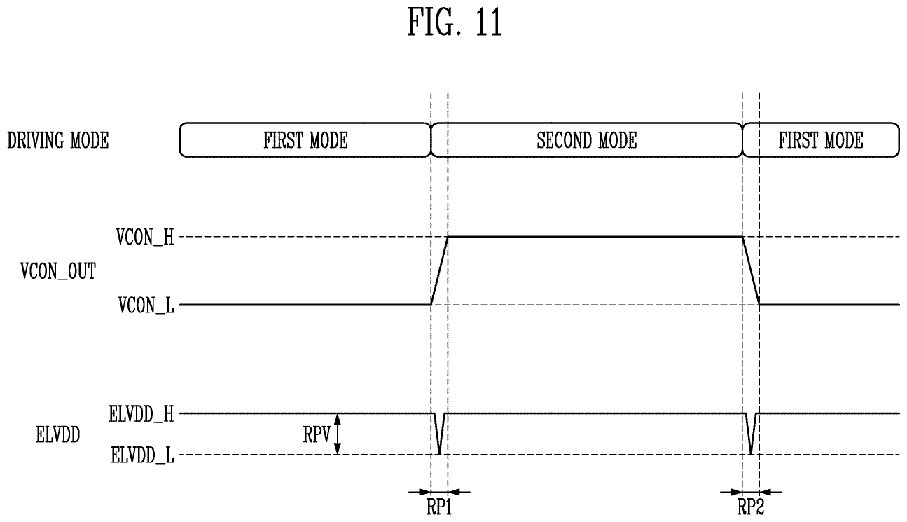

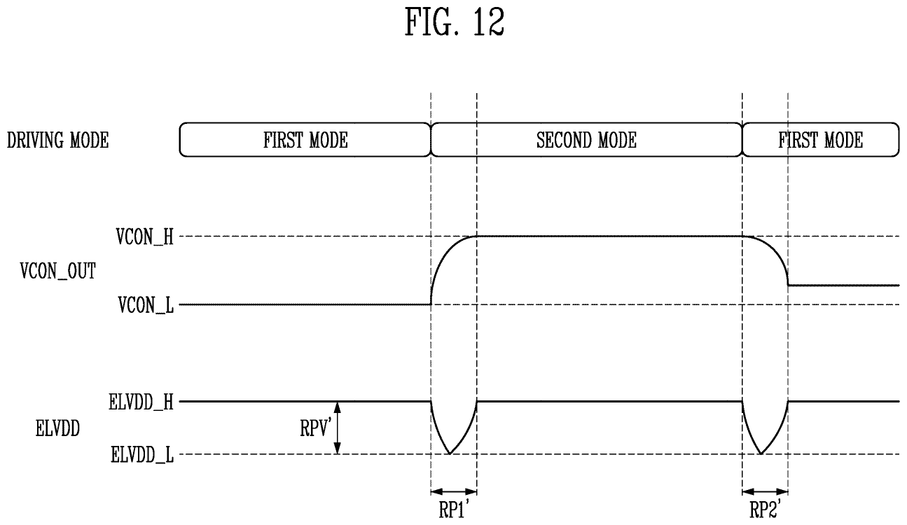

FIG. 11 is a diagram for describing the operation of the power supply in the first mode and the second mode according to some embodiments of the present disclosure. FIG. 12 is a diagram for describing an operation of a power supply in a first mode and a second mode in accordance with a comparative example.

Referring to FIGS. 8 to 11, the power supply (see 100 of FIG. 3) may operate in the first mode or the second mode. First, the operation of the power supply 100 in the first mode is described. In the first mode, the main controller 310 may output the output control signal VCON_OUT of the low level VCON_L. Thereafter, the main controller 310 may supply the output control signal VCON_OUT of the low level VCON_L to the first converter (see 321 of FIG. 3). At this time, the first converter 321 may output the first power supply voltage ELVDD of the high level ELVDD_H. For example, the first converter 321 may output the first power supply voltage ELVDD of the high level ELVDD_H to the display panel (see 200 of FIG. 1).

The power supply 100 may switch from the first mode to the second mode and then operate in the second mode. For example, during the first conversion section RP1, the output control signal VCON_OUT may transition from the low level VCON_L to the high level VCON_H. In other words, during the first conversion section RP1, the main controller 310 may output the output control signal VCON_OUT between the low level VCON_L and the high level VCON_H to the first converter 321. Accordingly, ripples may occur in the first power supply voltage ELVDD output from the first converter 321 during the first conversion section RP1. At this time, the stability of the output of the first power supply voltage ELVDD may have a significant effect on the light emission of the pixels (see PX of FIG. 1).

Meanwhile, referring to FIGS. 11 and 12, in accordance with a comparative example, the time for an output control signal VCON_OUT′ to transition from a low level VCON_L′ to a high level VCON_H′ may be relatively long. In other words, the time interval of the first conversion section RP1′ of FIG. 12 may be longer than the time interval of the first conversion section RP1 of FIG. 11. Accordingly, ripples of the first power supply voltage ELVDD′ in accordance with the comparative example may occur relatively great. In other words, a ripple change value RPV′ between the high level ELVDD_H′ and the low level ELVDD_L′ of the first power supply voltage ELVDD′ in accordance with the comparative example may be greater than a ripple change value RPV between the high level ELVDD_H and low level ELVDD_L of the first power supply voltage ELVDD according to some embodiments of the present disclosure.

According to some embodiments of the present disclosure, when switching from the first mode to the second mode, the voltage level of the output control signal VCON_OUT may transition relatively quickly. For example, with reference to FIGS. 8 to 10, the switch controller SWC may turn on the twenty-second switch SW22 in the first mode to charge the second capacitor C2 with the second clamp voltage VCLP_H. Thereafter, when switching from the first mode to the second mode, the switch controller SWC may turn on the twelfth switch SW12 to discharge the previously charged second clamp voltage VCLP_H to the third node N3. At this time, the level of the second clamp voltage VCLP_H may be the same as the high level VCON_H of the output control signal VCON_OUT. Accordingly, the main controller 310 may transition the output control signal VCON_OUT to the high level VCON_H in a relatively short time. Accordingly, the ripple change value RPV between the high level ELVDD_H and the low level ELVDD_L of the first power supply voltage ELVDD may be relatively small, and the quality of the image displayed by the display device (see 1000 of FIG. 1) may be relatively improved.

In the second mode, the main controller 310 may output the output control signal VCON_OUT of the high level VCON_H. Thereafter, the main controller 310 may supply the output control signal VCON_OUT of the high level VCON_H to the first converter 321. At this time, the first converter 321 may output the first power supply voltage ELVDD of the high level ELVDD_H. For example, the first converter 321 may output the first power supply voltage ELVDD of the high level ELVDD_H to the display panel 200.

The power supply 100 may switch from the second mode to the first mode and then operate in the first mode.

For example, during the second conversion section RP2, the output control signal VCON_OUT may transition from the high level VCON_H to the low level VCON_L. In other words, during the second conversion section RP2, the main controller 310 may output the output control signal VCON_OUT between the high level VCON_H and the low level VCON_L to the first converter 321. Accordingly, ripples may occur in the first power supply voltage ELVDD output from the first converter 321 during the second conversion section RP2.

Meanwhile, referring to FIGS. 11 and 12, in accordance with a comparative example, the time for an output control signal VCON_OUT′ to transition from a high level VCON_H′ to a low level VCON_L′ may be relatively long. In other words, the time interval of the second conversion section RP2′ of FIG. 12 may be longer than the time interval of the second conversion section RP2 of FIG. 11. Accordingly, a ripple change value RPV′ between the high level ELVDD_H′ and the low level ELVDD_L′ of the first power supply voltage ELVDD′ in accordance with the comparative example may be greater than a ripple change value RPV between the high level ELVDD_H and low level ELVDD_L of the first power supply voltage ELVDD according to some embodiments of the present disclosure.

According to some embodiments of the present disclosure, when switching from the second mode to the first mode, the voltage level of the output control signal VCON_OUT may transition relatively quickly. For example, with reference to FIGS. 8 to 10, the switch controller SWC may turn on the eleventh switch SW11 in the second mode to charge the first capacitor C1 with the first clamp voltage VCLP_L. Thereafter, when switching from the second mode to the first mode, the switch controller SWC may turn on the twenty-first switch SW21 to discharge the previously charged first clamp voltage VCLP_L to the third node N3. At this time, the level of the first clamp voltage VCLP_L may be the same as the low level VCON_L of the output control signal VCON_OUT. Accordingly, the main controller 310 may transition the output control signal VCON_OUT to the low level VCON_L in a relatively short time. Accordingly, the ripple change value RPV between the high level ELVDD_H and the low level ELVDD_L of the first power supply voltage ELVDD may be relatively small, and the quality of the image displayed by the display device 1000 may be relatively improved.

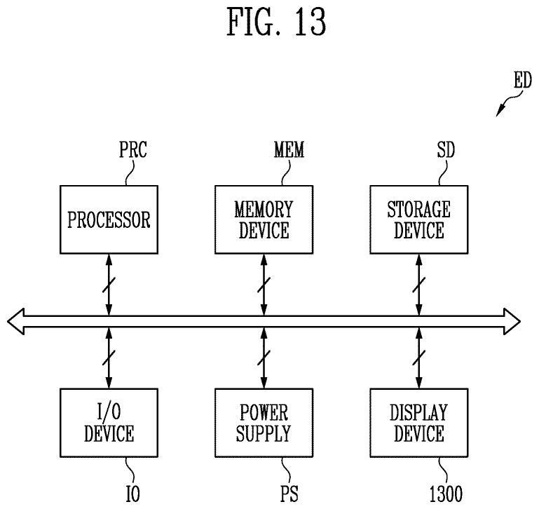

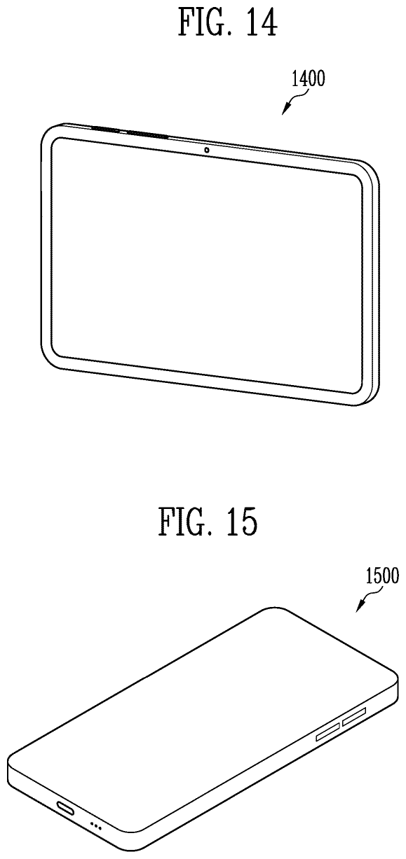

FIG. 13 is a block diagram illustrating an electronic device including a display device according to some embodiments of the present disclosure. FIG. 14 is a perspective view illustrating an example in which the electronic device of FIG. 13 is implemented as a tablet personal computer (PC). FIG. 15 is a perspective view illustrating an example in which the electronic device of FIG. 13 is implemented as a smartphone.

Referring to FIG. 13, an electronic device ED may include a processor PRC, a memory device MEM, a storage device SD, an input/output (IO) device IO, a power supply PS, and a display device 1300. At this time, the display device 1300 may be the display device 1000 of FIG. 1. In addition, the electronic device ED may further include a plurality of ports capable of communicating with a video card, a sound card, a memory card, a universal serial bus (USB) device, or other systems. According to some embodiments, the electronic device ED may be implemented as a tablet PC. However, this is only an example, and the electronic device ED is not limited thereto. For example, the electronic device ED may be implemented as a mobile phone, a video phone, a smart pad, a smart watch, a vehicle navigation, a computer monitor, a laptop, a head mounted display, etc.

The processor PRC may perform specific computations or tasks. According to some embodiments, the processor PRC may be a microprocessor, a central processing unit, an application processor, etc. The processor PRC may be connected to other components through an address bus, a control bus, and a data bus. According to some embodiments, the processor PRC may also be connected to an expansion bus such as a peripheral component interconnect (PCI) bus.

The memory device MEM may store data necessary for the operation of the electronic device ED. For example, the memory device MEM may include non-volatile memory devices, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM), or a ferroelectric random access memory (FRAM) devices, and/or volatile memory devices, such as a dynamic random access memory (DRAM) device, a static random access memory (SRAM) devices, or a mobile DRAM device.

The storage device SD may include a solid state drive (SSD), a hard disk drive (HDD), a compact disc read only memory (CD-ROM), etc.

The I/O device IO may include an input means, such as a keyboard, a keypad, a touch pad, a touch screen, or a mouse, and an output means, such as a speaker or a printer. According to some embodiments, the display device 1300 may be included in the I/O device IO.

The power supply PS may supply power required for the operation of the electronic device ED. For example, the power supply PS may be a power management integrated circuit (PMIC). According to some embodiments, the power supply PS may be located outside the display device 1300 as illustrated in FIG. 13. At this time, the power supply PS may operate in the same manner as the power supply 100 of FIG. 1. However, the present disclosure is not limited thereto.

The display device 1300 may display an image corresponding to visual information of the electronic device ED. At this time, the display device 1300 may be an organic light emitting display device or a quantum dot light emitting display device, but the present disclosure is not limited thereto. The display device 1300 may be connected to other components via the buses or other communication links.

Referring to FIG. 14, power loss of a tablet PC 1400 including the display device. According to some embodiments of the present disclosure may be minimized or relatively reduced and the quality of displayed images may be relatively improved.

Referring to FIG. 15, power loss of a smartphone 1500 including the display device. According to some embodiments of the present disclosure may be minimized or relatively reduced and the quality of displayed images may be relatively improved.

According to some embodiments of the present disclosure, the power loss of the power supply may be minimized or relatively reduced by reducing the switching frequency through independent operations in the first mode and the second mode.

In addition, according to some embodiments of the present disclosure, when switching the driving mode, the transition time of the control signal may be reduced to output the power supply voltage with improved reliability and the quality of the image displayed on the display panel may be relatively improved.

Characteristics of embodiments are not limited to those described above, and further various characteristics are included in the present specification.

Although specific embodiments and applications are described herein, other embodiments and variations may be derived from the description provided above. Therefore, embodiments according to the present disclosure are not limited to the specifically described embodiments but extends to the claims set forth below and their equivalents.

What is claimed is:

1. A power supply comprising:
a converter configured to output a power supply voltage based on an output control signal;
a first capacitor configured to discharge a first clamp voltage to a first resistor in a first mode and be to charged with the first clamp voltage in a second mode; and
a second capacitor configured to be charged with a second clamp voltage in the first mode and to discharge the second clamp voltage to the first resistor in the second mode.

2. The power supply of claim 1, further comprising a plurality of switches configured to be independently driven according to the first mode and the second mode.

3. The power supply of claim 2, wherein the plurality of switches comprise:
a first sub-switch and a third sub-switch connected in parallel to the first capacitor; and
a second sub-switch and a fourth sub-switch connected in parallel to the second capacitor.

4. The power supply of claim 3, wherein the first sub-switch and the second sub-switch are configured to be turned off in the first mode and configured to be turned on in the second mode, and
the third sub-switch and the fourth sub-switch are configured to be turned on in the first mode and configured to be turned off in the second mode.

5. The power supply of claim 4, wherein the third sub-switch is between the first capacitor and the first resistor, and
the second sub-switch is between the second capacitor and the first resistor.

6. The power supply of claim 3, further comprising an output buffer configured to supply the second clamp voltage to the second capacitor in the first mode and to supply the first clamp voltage to the first capacitor in the second mode.

7. The power supply of claim 6, wherein the first sub-switch is between the first capacitor and the output buffer, and
the fourth sub-switch is between the second capacitor and the output buffer.

8. The power supply of claim 1, further comprising a comparator configured to supply an input control signal to an output terminal,
wherein the output terminal is configured to output the output control signal based on a voltage applied to a first node between the comparator and the first resistor.

9. The power supply of claim 8, wherein the output control signal has a voltage of a first level in the first mode and a voltage of a second level in the second mode.

10. The power supply of claim 9, wherein the voltage of the first level and the voltage of the second level are equal to the first clamp voltage and the second clamp voltage, respectively.

11. The power supply of claim 10, wherein a time taken when the output control signal transitions from the voltage of the first level to the voltage of the second level is proportional to a change value of the power supply voltage when switching from the first mode to the second mode.

12. A display device comprising:
a display panel comprising pixels;
a main controller configured to supply an output control signal to a converter; and
one or more converters configured to supply, to the pixels, a power supply voltage generated based on the output control signal,
wherein the main controller comprises:
a first capacitor configured to discharge a first clamp voltage to a first resistor in a first mode and be charged with the first clamp voltage in a second mode; and
a second capacitor configured to be charged with a second clamp voltage in the first mode and discharge the second clamp voltage to the first resistor in the second mode.

13. The display device of claim 12, wherein the converter is configured to output the power supply voltage in a first driving method in the first mode and to output the power supply voltage in a second driving method in the second mode.

14. The display device of claim 13, wherein the converter comprises a plurality of transistors configured to be turned on alternately with each other, and
during a same time interval, a turn-on number of the plurality of transistors in the second driving method is less than a turn-on number of the plurality of transistors in the first driving method.

15. The display device of claim 12, wherein the power supply voltage comprises a first power supply voltage and a second power supply voltage lower than the first power supply voltage, and
the converter comprises:
a first converter configured to supply the first power supply voltage to the pixels; and
a second converter configured to supply the second power supply voltage to the pixels.

16. The display device of claim 12, further comprising a plurality of switches configured to be independently driven according to the first mode and the second mode.

17. The display device of claim 16, wherein the plurality of switches comprise:
an first sub-switch and a third sub-switch connected in parallel to the first capacitor; and
a second sub-switch and a fourth sub-switch connected in parallel to the second capacitor.

18. The display device of claim 17, wherein the first sub-switch and the second sub-switch are configured to be turned off in the first mode and configured to be turned on in the second mode, and
the third sub-switch and the fourth sub-switch are configured to be turned on in the first mode and configured to be turned off in the second mode.

19. The display device of claim 17, further comprising an output buffer configured to supply the second clamp voltage to the second capacitor in the first mode and to supply the first clamp voltage to the first capacitor in the second mode.

20. An electronic device comprising:
a processor configured to provide input image data to a display device;
the display device configured to display an image based on the input image data; and
a power supply configured to supply a power supply voltage to the display device,
wherein the power supply comprises:
a converter configured to output a power supply voltage based on an output control signal;
a first capacitor configured to discharge a first clamp voltage to a first resistor in a first mode and to be charged with the first clamp voltage in a second mode; and
a second capacitor configured to be charged with a second clamp voltage in the first mode and to discharge the second clamp voltage to the first resistor in the second mode.
